(19) United States
(12) Patent Application Publication
(10) Pub. No.: US 2026/0157343 A1
(43) Pub. Date: Jun. 11, 2026

(54) ANIMAL TAGGING SYSTEM FOR SIMULTANEOUS HUMAN AND COMPUTER-VISION-BASED ANIMAL IDENTIFICATION

(71) Applicant: Olden Labs, PBC., Allston, MA (US)

(72) Inventors: Michael Florea, Allston, MA (US); Pratomo Alimsijah, Palo Alto, CA (US); Michal Kaca, Pacifica, CA (US); Noah Weber, Mill Valley, CA (US)

(21) Appl. No.: 19/183,432

(22) Filed: Apr. 18, 2025

Related U.S. Application Data
(60) Provisional application No. 63/635,631, filed on Apr. 18, 2024.

(51) Int. Cl. A01K 11/00; A01K 29/00; G06N 3/02

(52) U.S. Cl. CPC A01K 11/004; A01K 11/002; A01K 29/005; G06N 3/02

(57) ABSTRACT

An animal tagging system for identifying and assaying multiple vertebrate animals, comprising a plurality of identification tags, each identification tag comprising a body with an identifier display area bearing an identifier, further having a male and a female parts, the identification tags applicable to ear or back skin and readable by human and computer vision from at least 5 cm. At least one controller is designed to monitor and record data from a plurality of sensors. A multi-object tracking software system is operationally coupled to at least one optical sensor, designed to track individual animals by detecting and reidentifying the identification tags, generating trajectories, and aggregating features, using at least one of appearance, motion, interaction, exclusion, and occlusion handling models, synchronized with sensor data via a time-measuring device. At least one physiological software system is designed to analyze sensor and tracking data to measure health parameters.

### CROSS REFERENCE TO RELATED APPLICATIONS

This application claims priority to and the benefit of U.S. application 63/635,631 titled ANIMAL TAGGING SYSTEM FOR SIMULTANEOUS HUMAN AND COMPUTER-VISION-BASED ANIMAL IDENTIFICATION filed on Apr. 18, 2024, which is incorporated herein by reference in its entirety.

### FIELD OF THE INVENTION

The invention relates to laboratory animal identification and tracking using physical identifier tags.

### BACKGROUND

Accurate identification of laboratory animals, particularly mice and rats, is essential for ensuring the reliability of scientific research outcomes and maintaining animal welfare. Various methods have been developed to tag or identify laboratory rodents, each with distinct applications, advantages, and limitations. These methods include car notching, car tagging, tattooing, color marking, toe clipping, and RFID (Radio-Frequency Identification) chipping.

Ear notching involves creating small, patterned cuts in the ears to assign unique identifiers. This technique is cost-effective, requires minimal equipment, and supports a large number of unique combinations, making it suitable for extensive colonies. However, it demands skill to ensure precision and minimize harm, is difficult to read from a distance, and may become unreliable if car tissue regrows or is damaged.

Ear tagging entails attaching numbered or barcoded metal or plastic tags to the animal's car, offering a visible and durable identification method. Tags can vary in color for quick recognition. While straightforward, tagging requires a specialized applicator and careful placement to avoid discomfort. One-piece metal tags are inexpensive but limited by weight and small numbering, necessitating animal restraint for reading. Two-piece plastic tags allow larger, more legible identifiers but involve complex, costly manufacturing and application processes. Additionally, tags may be lost if animals chew or tear the surrounding tissue.

Tattooing permanently marks the skin—typically on the tail, feet, or cars—by depositing ink into the dermal layer, ideal for pigmented strains where other methods are less visible. Tattoos can encode alphanumeric identifiers but require specialized equipment, training, and extended restraint, increasing procedural time and reducing throughput. Over time, tattoos may fade, complicating accurate identification.

Color marking uses non-toxic, temporary dyes or paints applied to the fur or tail. This method is quick, inexpensive, and non-invasive, suitable for short-term studies. However, dyes fade within days due to grooming, requiring frequent reapplication, and are ineffective on dark-furred animals where visibility is limited.

Toe clipping, involving the partial removal of one or more toes, provides a permanent identifier but raises significant ethical concerns due to pain and welfare issues. It requires restraint for identification and is typically reserved for cases where alternatives are impractical, performed under strict anesthesia protocols.

RFID chipping implants a microchip under the skin, encoding a unique number readable by a scanner. This method is reliable, unobtrusive, and ideal for long-term or breeding studies. However, it involves high costs for equipment and chips, lacks visual identifiability, and requires scanning multiple animals to locate a specific individual. Chip failure can also result in permanent loss of identification.

Therefore, there is a longfelt need in the market for an improved laboratory rodent and other animal identification solution to simultaneously provide immediate visibility for efficient, humane, and reliable animal identification in scientific research.

### SUMMARY OF THE INVENTION

Disclosed is an animal tagging system for identifying and assaying multiple vertebrate animals, comprising a plurality of identification tags, each tag comprising a body (≤0.25 g) with an identifier display area (≥4×4 mm) bearing at least one number, letter, or symbol, a male part, a female part with a friction-fit lock mechanism adapted to receive said pin, the identification tags applicable to car or back skin and designed to be readable by human and computer vision from at least 5 cm without animal restraint. At least one controller is designed to monitor and record data from a plurality of sensors, including but not limited to optical sensors, motion sensors, weight sensors, force meter sensors, and cameras, including infrared cameras, the sensors designed to monitor the environment and the vertebrate animals. A multi-object tracking software system is operationally coupled to at least one optical sensor, designed to track individual animals by detecting and reidentifying the identification tags, generating trajectories, and aggregating features, using at least one of appearance, motion, interaction, exclusion, and occlusion handling models, synchronized with sensor data via a time-measuring device. At least one physiological software system is designed to analyze sensor and tracking data to measure animal health parameters, including, but not limited, to movement and activity, position in a cage, rearing and climbing, fighting, eating, drinking, sleeping, grooming, nesting, mating, birthing, social distancing, and any other behaviors that might be determined by patterns of movement individually and relative to objects and other animals.

Identification tags may be made of a biocompatible material selected from the group consisting of thermoplastic, metals, including metals and composites selected for properties such as weight, reflectivity, and corrosive resistance, where an important consideration is to ensure non-irritation and non-toxicity to the animals. The animal tagging system may further comprise a tag applicator configured to apply the identification tags to animal ear or back skin, the applicator comprising pliers or a typically spring-coiled mechanism to hold and lock the male and female parts, where an important consideration is to minimize animal stress. The tag applicator may include grooves or holes to release a disposable linker connecting the male and female parts during application.

The animal tagging system is designed to be a component of a software-supported analysis system wherein the tags substantially form physicalized data points designed to be easily trackable by machine and yet also easily identifiable by a person who may, in a laboratory setting, have reason to observe or retrieve animals manually and may need to identify given animals among a plurality of animals easily. Software has a supportive role in enhancing what would be difficult or impossible for a person to do, such as track and precisely record the movement of multiple animals (Aₘ) from a plurality of animals (Aₙ) in real time. Therefore, it is one object of the identification tag to bridge the gap where human observation goes beyond being inconvenient and expensive to when analysis goes beyond what a human or even multiple humans can perform.

Software used in the animal tagging system may be multi-object tracking software that includes a deep learning (DL) designed to recognize tag symbols, enhance individual animal identification in co-housed settings, and assess associated animal activity. A specific example is a convolutional neural network (CNN) designed to recognize tag symbols, enhance individual animal identification in co-housed settings, and assess associated animal activity.

Software used in the animal tagging system may be multi-object tracking software that includes a supervised learning algorithm designed to recognize tag symbols, enhance individual animal identification in co-housed settings, and assess associated animal activity, An example is Support Vector Machines (SVMs) designed to recognize tag symbols, enhance individual animal identification in co-housed settings, and assess associated animal activity.

Software used in the animal tagging system may be multi-object tracking software that includes a graph-based neural network (GNN) configured to model spatial and social interactions among multiple vertebrate animals, using integrated tag data to maintain individual identities during complex group behaviors, such as crowding or occlusion events.

The animal tagging system may further include a linker with each tag designed to join male and female parts of the identification tag. The identification tags are designed to be illuminated by an overhead LED screen designed to display a looming spot for vision assays and at least one infrared or near-infrared camera designed to continuously record video. The infrared or near-infrared cameras may include a high-pass filter designed to prevent interference from the LED screen's visible light. This high-pass filter in this embodiment is typically designed for the identification tag to be visible in the near infrared (600-1500 nm) spectrum.

The animal tagging system may further comprise dynamically adjusting the interval of video frame capture by the at least one infrared or near-infrared camera based on the density or activity level of the vertebrate animals within the cage, optimizing data storage while maintaining accurate tracking of individuals identified by the plurality of identifier tags.

The animal tagging system may further include a control panel designed to display information recorded about at least one identification tag, which information may further be recorded about the animal to which said identification tag is attached. The animal tagging system may further comprise at least one RFID reader disposed on the outer housing assembly to supplement tag-based identification. The animal tagging system may include a controller further configured to execute an automated calibration routine that adjusts the multi-object tracking software's recognition parameters based on the optical properties of the identification tag under varying cage lighting conditions.

Embodiments of the invention may be assembled as a laboratory animal identification and assaying kit, comprising the plurality of identification tags, each with the lightweight body (≤0.25 g), the identifier display area (≥4×4 mm) bearing the at least one number, letter, or symbol, the male part, the female part, and the optional linker, applicable to animal ear or back skin. Included would be the tag applicator designed to attach tags with minimal animal stress. Included is the system for defining a trackable space with inner and outer housing assemblies, and the controller operably coupled to the at least one multi-object tracking software. Instructions would be included for applying tags and operating the system to monitor and assay multiple vertebrate animals. The laboratory animal identification and assaying kit may further comprise a software interface designed for real-time visualization of individual animal trajectories and health parameters.

Disclosed further is an associated and representative method illustrating how the animal tagging system is used, which shall be further detailed in the detailed description below.

It is an object of the invention to provide an identification tag that is minimally invasive to the tagged animal, can be used unaided by a person, and that is readily observable and trackable by machine, where to select how best to perform giving experiments and balancing cost and effectiveness, the identification tag can be equally useful to human and machine-based assessments, determinations, and actions from the observation orientation of the given laboratory exercise.

It is further an object of the invention that, from the orientation of a given experiment, the identification tag raises effective visibility of the animal subjects for humans and machines under their respective analysis decision cycles of assessment, decision including determining or predicting what assessments mean, and action, where action includes at least recording and aggregating data.

It is a further object of the invention that the identification tags, particularly for mouse cars, have been designed for camera-based identification, where the identification tag must be disposed on a top portion of the ear and reliably remain with the identifier display area face up. To do that, one must tag deeply inside the top portion. To be able to do that, the holder of the tag female part must be sufficiently narrow, the female itself small, and a male pin must be offset enough where it extends from the identification tag to fit in a targeted section of mouse ears.

Further objects of the invention are that the identification tags are specifically configured for attachment to the topmost narrow portion of a mouse ear, and wherein the female part and its holder are miniaturized enough to fit within said narrow region, and the male part includes an offset pin as illustrated enabling angular insertion. The tag applicator includes an asymmetric or angled insertion head and a refined release mechanism for minimizing torque on the animal's ear during application for the object of minimizing animal stress. The tag applicator may further include a second applicator head designed for use on back skin, the head being configured to apply tags via perpendicular insertion through skin tissue, likewise supporting the object of the invention to minimize animal stress. Identification tags designed for use on back skin and include a modified male part and female part with increased surface area to account for skin elasticity.

These and other objects, features, and advantages of the present invention will become readily apparent upon a review of the following detailed description of the invention, in view of the drawings and appended claims.

### BRIEF DESCRIPTION OF THE DRAWINGS

The nature and mode of the operation of the present invention will now be more fully described in the following detailed description of the invention taken with the accompanying drawing figures, in which:

FIGS. 1A-G illustrates representative identification tags;

FIG. 2A illustrates a representative deployment with identification tags attached to animals ears;

FIG. 2B illustrates a representative deployment with identification tags attached to animals back skin;

FIG. 3 illustrates representative deployments of identification tags within a housing assembly;

FIG. 4A-F illustrates a representative identification tag applicator;

FIG. 5 illustrates a control panel;

FIG. 6 illustrates an animal tagging system kit;

FIG. 7A-B illustrates a representative animal tagging system method using identification tags; and

FIG. 8 illustrates mouse with proper identification tag location.

### DETAILED DESCRIPTION OF THE INVENTION

Following are detailed descriptions of various related concepts related to, and embodiments of, methods and apparatus according to the present disclosure. It should, however, be understood that this disclosure is not limited to the particular methodology, materials, and modifications described and, as such, may, of course, vary. It is also understood that the terminology used herein is for the purpose of describing particular aspects only and is not intended to limit the scope of the claims.

Furthermore, it should be appreciated that drawings are representative to illustrate the inventive concepts herein and may not be to scale. Also, like drawing numbers on different drawing views identify identical, or functionally similar, structural elements where there could appear some variations on exactness where exactness is not material to the inventive concept herein. It is to be understood that the claims are not limited to the disclosed aspects.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “distal” and comparably related terms denoting further-away portions of an item are antonymous to proximal portions of the co-described item as those portions of items may be termed. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, when referring to a set or group of items, for illustration (A, B, C) the term “at least one or more . . . and . . . ” such as in “at least one or more of A, B, and C” is intended to include any to all of the denoted set or group of items, i.e. it could include just one item from the set or group, it could include all of the items from the set or group, and it could include any other combination of the set or group of items that is greater than one item and less than all of the items, the illustrated example having three items meaning there are up to seven non-ordered combinations A, B, C, AB, AC, BC, ABC. Other numbers of items would have maximum combination possibilities calculated accordingly.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

The term between as used in this disclosure includes the value denoting the endpoints of the set. For illustration, a value between A and B includes A and any value A that is less than B and it includes B and any value that is greater than A, according to the discrete or continuous limitations of what value in the set can constitute a value.

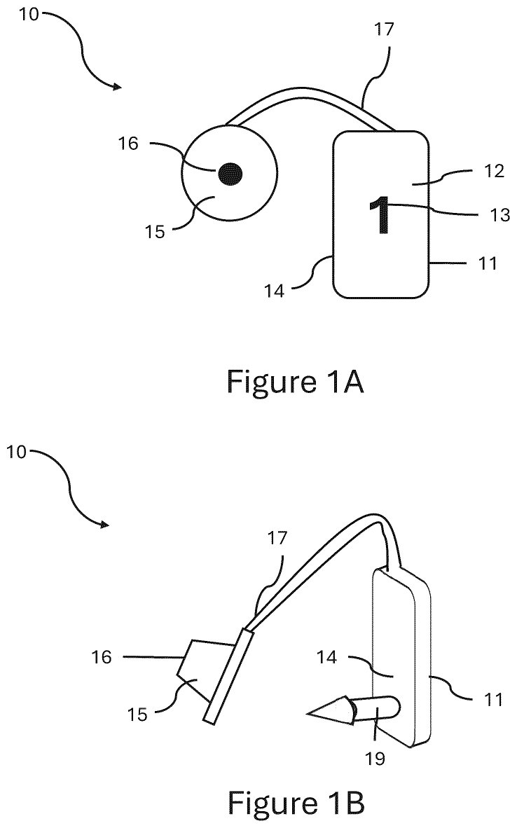

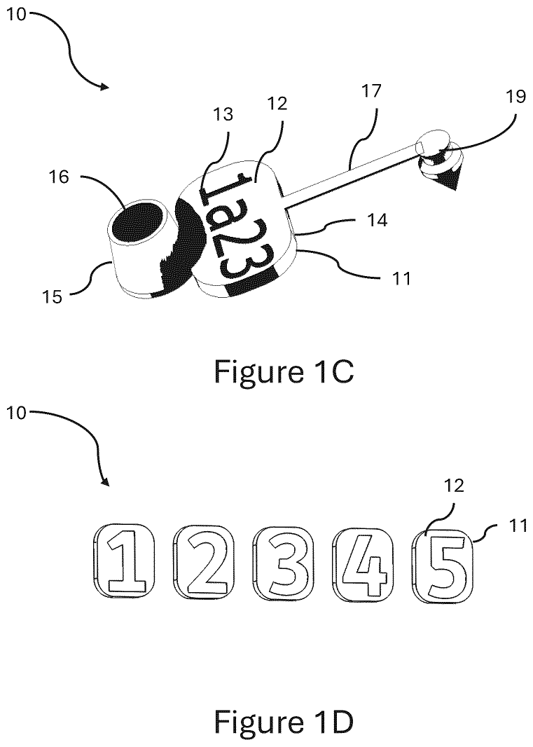

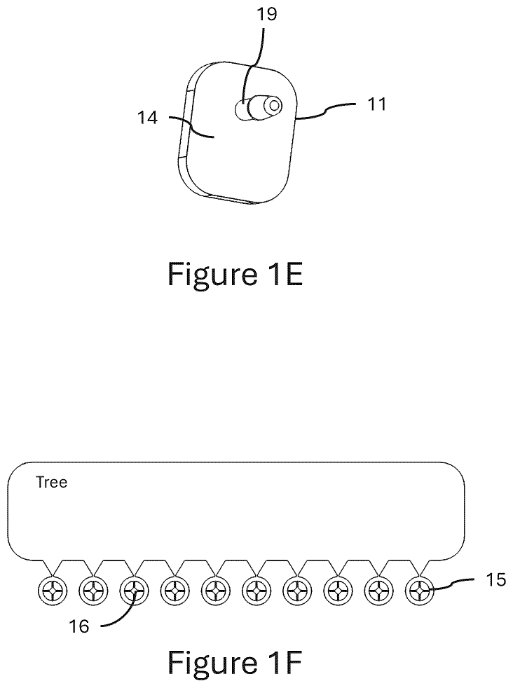

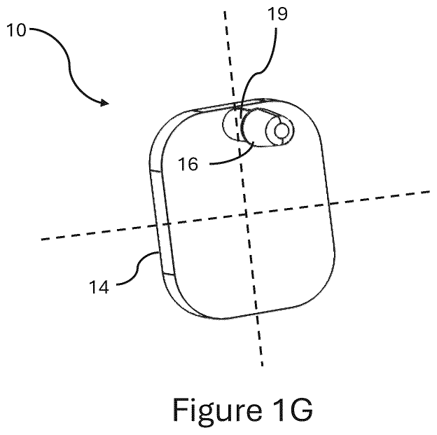

Disclosed in FIGS. 1A-1G are representative identification tags 10. Each identification tag 10 in this representative embodiment comprises body 11 (≤0.25 g) with identifier display area 12 (≥4×4 mm) bearing at least one identifier 13, which would typically be a number, letter, or symbol, or combination thereof. Identification tag 10 includes male part 14 a male part with offset pin 19 and female part 15 with friction-fit lock mechanism 16 adapted to receive pin 19. Included may be disposable linker 17 connecting male parts 14 and female parts 15 during application. Linker 17 would be removed after identification tag 10 application.

FIGS. 1A-1G further illustrate that identification tag 10 is typically constructed with a miniaturized female part 15 and a narrow (4 mm) female base holder to facilitate tagging in the illustrated region. Male part 14 includes an offset pin 19 designed not to align centrally with the identifier display area 12, but rather to pierce through the thinner top edge of the ear. This offset configuration allows pin 19 to enter female part 15 at a precise location while enabling the identifier display area 12 to sit flat and unobstructed on the ear surface, maintaining the orientation of the identifier tag 10 for optimal readability by computer vision systems. The term “offset” is defined as placing pin 19 other than where, as illustrated in FIG. 1G, a longitudinal axis and latitudinal axis of identification tag 10 intersect.

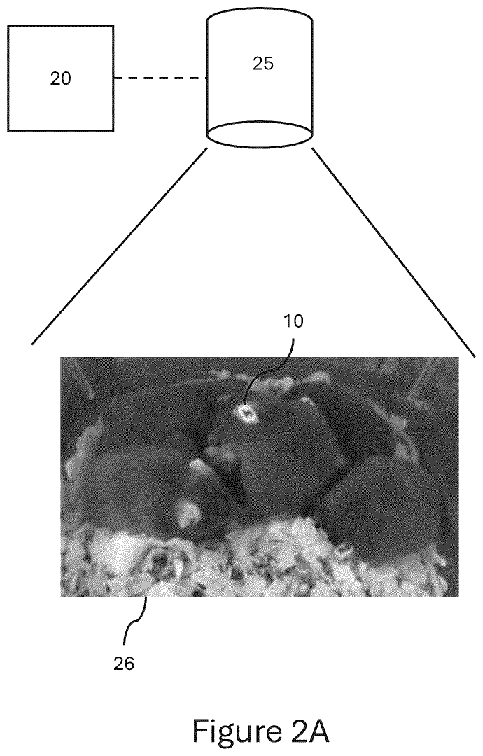

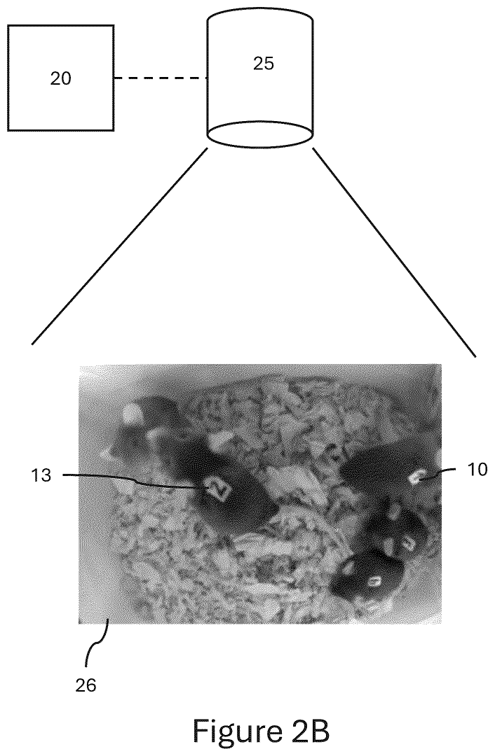

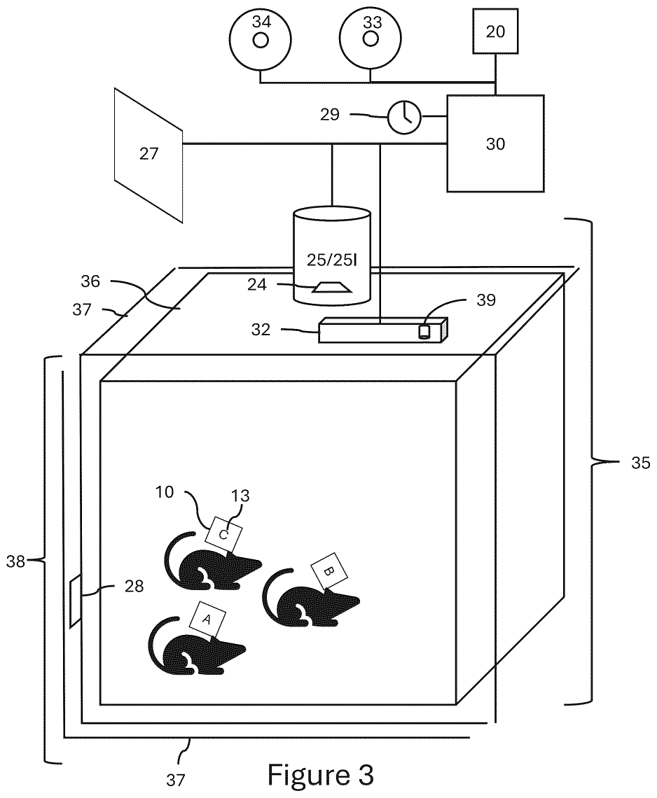

FIGS. 2A, 2B, and 3 illustrates that the tags are applied to car or back skin and are readable by human and computer vision 20 from at least 5 cm without animal restraint, this latter being a matter of ensuring identifier 13 is of a size and sharpness to match the resolution of said computer vision 20, which is a supported by at least one camera system 25, which may be infrared or near-infrared camera 25I. Further illustrated is video frame 26, which displays animals at given time (1) of that frame established by time measuring device 29.

FIG. 3 further illustrates cage 35, which in embodiments may be termed smart cage, and housing 38 that may have inner housing 36 and outer housing 37 wherein inner housing 36 may be removable from outer housing 37, and elements such as camera 25 and sensors 32, typically but not exclusively, are disposed on or operationally coupled to outer housing 37—but which required is only that such elements as camera 25 and sensors 32 have required fields or spans of observation and be, therefore, an element of cage 35. At least one controller 30 is designed to monitor and record data from a plurality of sensors 32, including but not limited to optical sensors 39, motion sensors, weight sensors, force meter sensors, and infrared cameras 25I, the sensors 32 designed to monitor the environment and the vertebrate animals therein. A multi-object tracking software system 33 is operationally coupled to at least one optical sensor 39 or camera 25 designed to track individual animals by detecting and reidentifying the identification tags 10, generating trajectories, and aggregating features, using at least one of appearance, motion, interaction, exclusion, and occlusion handling models, synchronized with sensor data via time-measuring device 29. At least one physiological software system 34 is designed to analyze sensors 32 and tracking data to measure animal health parameters, including, but not limited, to movement and activity, position in a cage, rearing and climbing, fighting, eating, drinking, sleeping, grooming, nesting, mating, birthing, social distancing, and any other behaviors that might be determined by patterns of movement individually and relative to objects and other animals.

Further illustrated in FIG. 3, identification tags 10 are designed to be illuminated by an overhead LED screen 27 designed to display a looming spot for vision assays and at least one infrared or near-infrared camera 25I designed to continuously record video. Infrared or near-infrared camera 25I may include high-pass filter 24 designed to prevent interference from visible light from LED screen 27. This high-pass filter 24 in this embodiment is typically designed for identification tag 10 to be visible in the near infrared (600-1500 nm) spectrum. RFID reader 28 may be disposed on outer housing assembly 37 of cage 35 to supplement tag-based identification. Controller 20 may be further configured to execute an automated calibration routine that adjusts the multi-object tracking software's 33 recognition parameters based on optical properties of identification tag 10 under varying cage lighting conditions.

Identification tags 10 may be made of a biocompatible material selected from the group consisting of thermoplastic, metals (including metals selected for properties such as weight, reflectivity, and corrosive resistance), and composites, where an important consideration is to ensure non-irritation and non-toxicity to the animals.

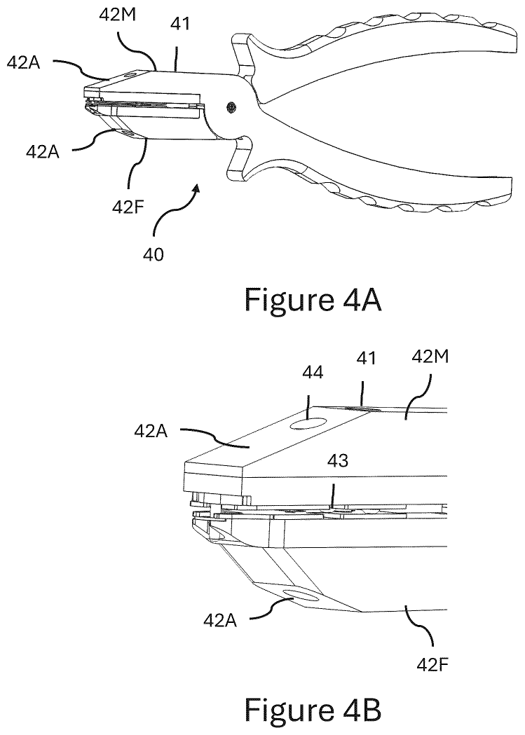

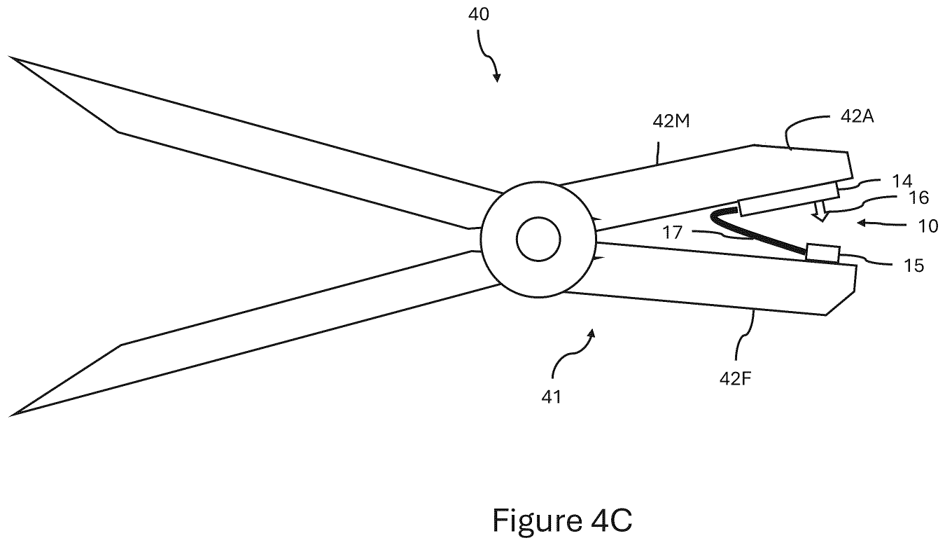

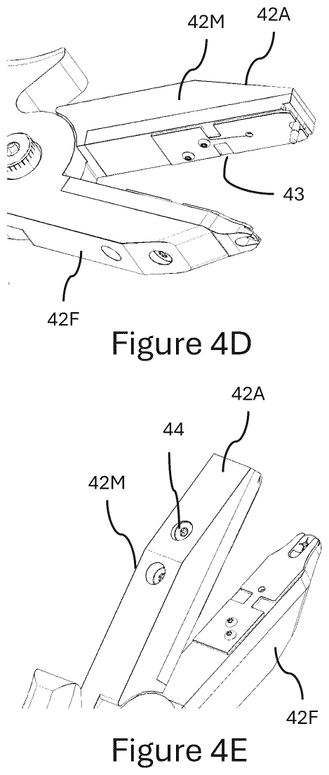

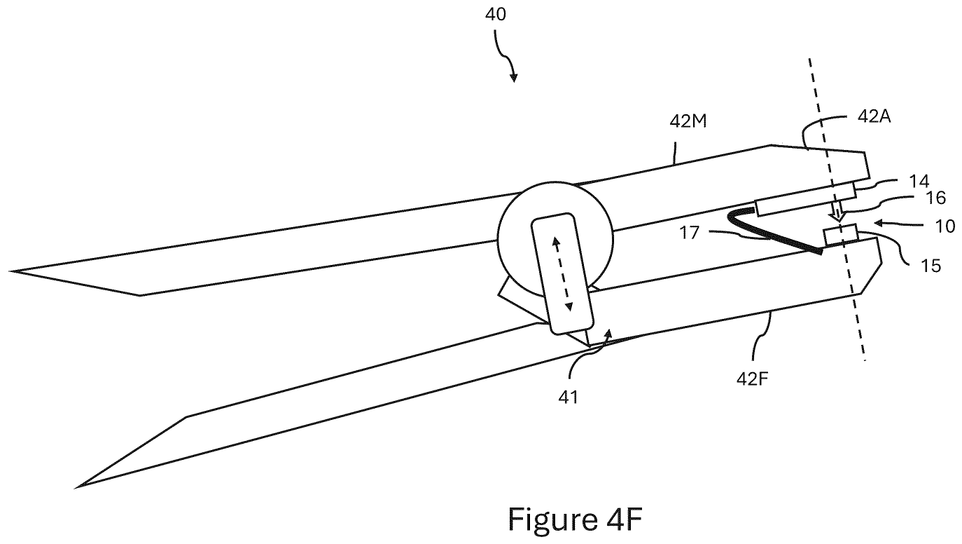

FIGS. 4A-4F illustrate that the animal tagging system may further comprise tag applicator 40 configured to apply identification tags 10 to animal cars or back skin. Applicator 40, in this representative embodiment, comprises pliers 41, though another typically spring-coiled mechanism could be used, designed to hold and lock male parts 14 and female parts 15, where an important consideration is to minimize animal stress by way of fast and efficient tagging. Tag applicator 40 may include grooves 43 or holes 44 to release disposable linker 17 connecting male parts 14 and female parts 15 during application.

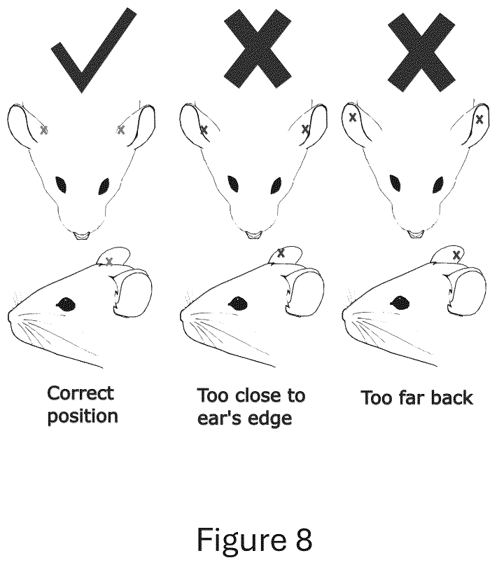

Identification tag 10 and plier 41 applicator 40 are specifically designed to work together as an invention. Conventional tag applicators are not suited for this application. Therefore, embodiments may include a tag applicator 40 specifically engineered for deep placement in the upper portion of animal cars, illustrated in FIG. 8. This applicator 40 incorporates an asymmetrical or first adjustable jaw mechanism 42F for female part 15 and second adjustable jaw mechanism 42M for male part 14, with noted asymmetry at jaw front part 42A, allowing users to hold and drive male pin 14 at an angle conducive to optimal positioning. In such embodiments, the release mechanism for linker 17 is refined to reduce applied force and minimize torque on the mouse car during insertion, thereby reducing animal stress and increasing identification tag 10 retention.

In alternative embodiments, illustrated in FIG. 4F, a similarly structured identification tag 10 may be applied to the back skin of mice using a tag applicator 40 having a perpendicular locking motion, in contrast to the angular motion required for car tagging. Applicator 40 illustrations are representative.

The animal tagging system is designed to be a component of a software-supported analysis system wherein the tags substantially form physicalized data points designed to be easily trackable by machine and yet also easily identifiable by a person who may, in a laboratory setting, have reason to observe or retrieve animals manually and may need to identify given animals among a plurality of animals easily. Software has a supportive role in enhancing what would be difficult or impossible for a person to do, such as track and precisely record the movement of multiple animals (Aₘ) from a plurality of animals (Aₙ) in real time. Therefore, it is one object of the identification tag to bridge the gap where human observation goes beyond being inconvenient and expensive to when analysis goes beyond what a human or even multiple humans can perform.

Software used in the animal tagging system may be multi-object tracking software 33 that includes a deep learning (DL) algorithm designed to recognize tag symbols, enhance individual animal identification in co-housed settings, and assess associated animal activity. A specific example is a convolutional neural network (CNN) designed to recognize tag symbols, enhance individual animal identification in co-housed settings, and assess associated animal activity. CNN may be designed to detect and reidentify identifiers 13. CNNs, for illustration, may process video frames 26 from cameras 25 or 25I to recognize numbers, letters, or symbols on the identifier tag 10 identifier display area 12 for individual animal identification. Animals may be tracked, analyzing spatial and temporal patterns in video data associated with video frames 26. CNNs may further generate trajectories and aggregate features (e.g., animal size, shape, tag markings) to maintain identities in co-housed settings. As a representative problem setup, CNN might suppose cage infrared/near-infrared cameras 25I capture video frames 26, each represented as a 2D grayscale image I∈R^{H×W}, where (H) and (W) are the height and width (e.g., 256×256 pixels). The goal is to detect and classify identification tag 10 identifiers 13 in a region of interest (ROI) within video frame 26, generally cropped to a smaller image patch X∈R^{h×w} (e.g., 32×32 pixels) containing identifier tag 10 identifier display area 12 (≥4×4 mm, scaled to pixel dimensions). CNN would, therefore, in this representative embodiment, take (X) as inputs and outputs of a probability distribution over (C) possible symbol classes (e.g., C=100 for a set of alphanumeric combinations such as “A1” to “J0”). Each class corresponds to a unique animal identity. CNN learns to map correct identifiers 13, enabling multi-object tracking software 33 to associate data from sensors 32 with specific animals.

Software used in the animal tagging system may be multi-object tracking software 33 that includes a supervised learning algorithm designed to recognize tag symbols, enhance individual animal identification in co-housed settings, and assess associated animal activity, An example is Support Vector Machines (SVMs) designed to recognize tag symbols, enhance individual animal identification in co-housed settings, and assess associated animal activity. SVMs could be trained to categorize behaviors by analyzing patterns in sensor outputs (e.g., motion, weight, force) or video features (e.g., trajectories derived from identification tags 10. For example, SVMs with an RBF kernel could classify whether an animal's movement speed or interaction with a run wheel indicates normal or abnormal behavior, correlating with given health metrics. Problem setup, for illustration, might start by supposing there is a dataset of (n) animals, each represented by a feature vector xᵢ∈R_{d}, then (d) could be the number of features extracted from the sensors 32 or video data from camera system 25 or 25I and associated computer vision 20.

Software used in the animal tagging system may be multi-object tracking software 33 that includes a graph-based neural network (GNN) configured to model spatial and social interactions among the multiple vertebrate animals, using identification tag 10 data to maintain individual identities during complex group behaviors, such as crowding or occlusion events. Representative embodiments could include GNNs designed to be used within the multi-object tracking software 33 to model spatial and social interactions among animals, enhancing identification and tracking via identification tags 10. Included in these embodiments are graph representations such as:
Nodes: Animals with identification tag 10 IDs), cage 22 landmarks, or tracking points.
Edges: Proximity (e.g., animals close together) or interactions (e.g., chasing).
Features: Node features include information tag 10 identifiers 13, positions, or sensor 32 data (e.g., velocity); edge features include distances or interaction types.

Included in these embodiments is functionality:
Tracking: GNNs refine trajectories by considering neighboring animals' positions, resolving occlusions (e.g., when animals overlap in video frames 26).
Behavior Analysis: Classify behaviors based on interaction patterns.
Occlusion Handling: Maintain identities during crowding by leveraging relational context

For example: A GNN may construct a graph where each animal is a node at time (t), with edges connecting animals within 10 cm. It aggregates features such as identifiers 13 and associated velocities to predict future positions or classify behaviors, ensuring accurate tracking in a multi-animal cage 22 environment. An example problem setup might be to consider a smart cage with (N) animals, each identified by an identifier 13 (e.g., “A3,” “B7”). The cage environment is modeled as a dynamic graph Gₜ=(Vₜ,Eₜ) at time (t), where:
Nodes (Vₜ): Represent the (N) animals, with each node vᵢ corresponding to an animal (i).
Edges (Eₜ): Connect pairs of animals within a proximity threshold (e.g., 10 cm, based on video-derived positions) or exhibiting interactions (e.g., grooming, chasing).
Position coordinates (x, y, z) in given cage 22.
Velocity (from trajectory tracking).
Sensor 32-derived metrics

The animal tagging system may further comprise dynamically adjusting the interval of video frame 26 capture by at least one infrared or near-infrared camera 25I based on the density or activity level of the vertebrate animals within cage 22, optimizing data storage while maintaining accurate tracking of individuals identified by the plurality of identifier tags 10.

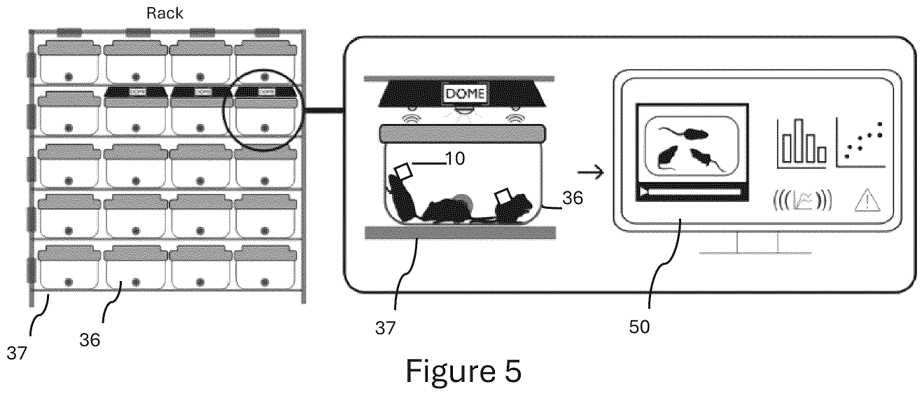

FIG. 5 illustrates that the animal tagging system may further include control panel 50 designed to display information recorded about at least one identification tag, which information may further be recorded about the animal to which said identification tag 10 is attached. Also illustrated is a rack embodiment of multiple cages 22, showing inner housings 36 and outer housings 37.

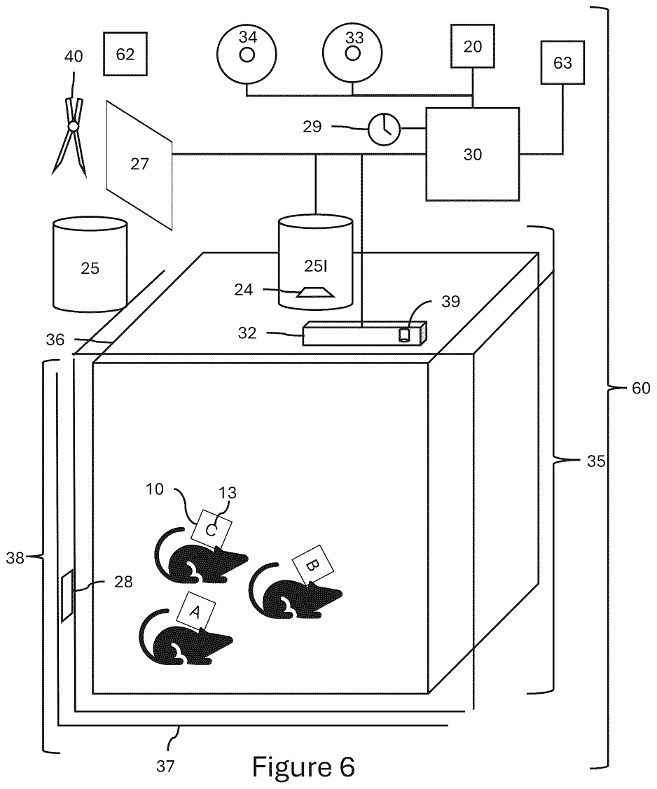

FIG. 6 illustrates that embodiments of the invention may be assembled as a laboratory animal identification and assaying kit 60, comprising the plurality of identification tags 10, each with body 11 (≤0.25 g), identifier display area 12 (≥4×4 mm) bearing at least one identifier 13 (number, letter, or symbol), male part 14 with offset pin 19, female part 15 with friction lock mechanism 16, and optional linker 17, applicable to animal car or back skin. Included would be tag applicator 40 such as pliers 41 designed to attach identification tags 10. Included is the system for defining a trackable space with inner housing assemblies 36 and outer housing assemblies 37, and controller 30 operably coupled to multi-object tracking software 33 and physiological software 34. Instructions 62 would be included for applying identification tags 10 and operating the system to monitor and assay multiple vertebrate animals. The laboratory animal identification and assaying kit 60 may further comprise a software interface 63 designed for real-time visualization of individual animal trajectories and health parameters.

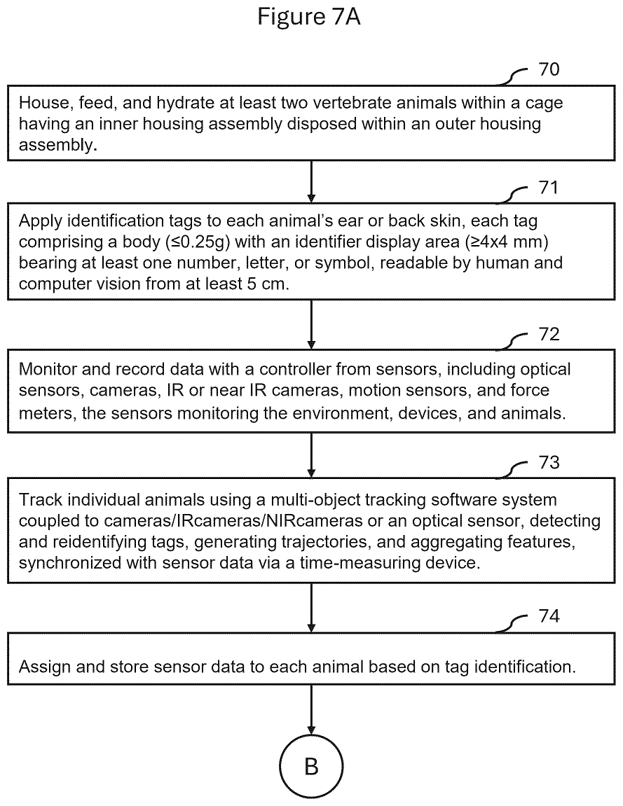

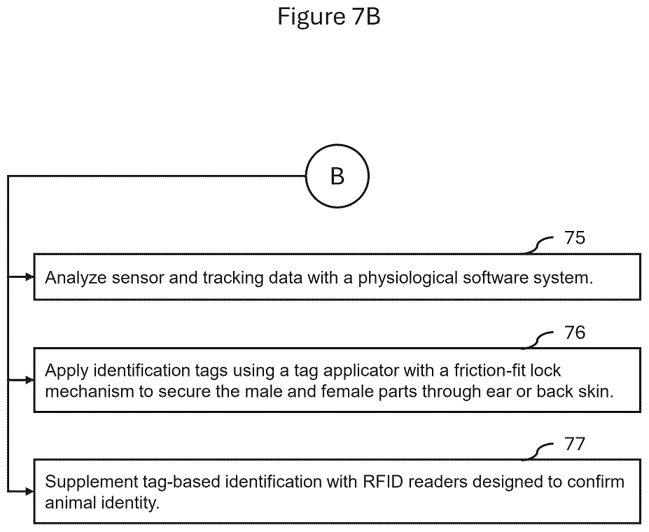

FIG. 7A-7B illustrates a method for identifying and assaying multiple tagged vertebrate animals, including the step of 70, housing, feeding, and hydrating at least two vertebrate animals within cage 22 that may include inner housing assembly 36 disposed within outer housing assembly 37. The method further includes the step of 71, applying identification tags 10 to each animal's ear or back skin, each identification tag 10 comprising a body 11 (≤0.25 g) with an identifier display area 12 (≥4×4 mm) bearing identifier 13 which is at least one number, letter, or symbol, designed to be readable by human and computer vision 20 from at least 5 cm. The method further includes the step of 72, monitoring and recording data with a controller 30 from sensors 32, including cameras 25/25I optical sensors 39, and such sensors as motion sensors, and force meters, sensors 32 monitoring the environment, devices, and animals. The method further includes the step of 73, tracking individual animals using a multi-object tracking software system 33 operationally coupled to cameras 25/25I or optical sensor 39, detecting and reidentifying identification tags 10, generating trajectories, and aggregating features, synchronized with sensor data via time-measuring device 29. The method further includes the step of 74, assigning and storing sensor 32 data to each animal based on tag identification.

The method may further include the step of 75, analyzing sensor 32 and tracking data with physiological software system 34. The method may further include the step of 76, applying identification tags 10 using tag applicator 40 with friction-fit lock mechanism 16 to secure male parts 14 and female parts 15 through animal ear or back skin. The method may further include the step of 77, supplementing tag-based identification with RFID readers 28 designed to confirm animal identities.

FIG. 8 illustrates that identification tag 10 is designed specifically to be placed on the topmost narrow portion of a mouse's ear, a region that has historically not been used for tagging due to its limited surface area and difficulty of access. However, it has been discovered that placing a tag in this location provides significantly improved visibility for overhead and cage-mounted cameras 25, as the region is less prone to obstruction and motion blur compared to traditional tagging locations. This specific location ensures that identifier 13 remains in consistent view during animal movement, greatly enhancing camera-based detection reliability and reducing errors in automated animal identification.

Various related embodiments of the inventive concept are also described in the drawings, which are incorporated herein by reference in their entirety.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings

### LIST OF REFERENCE NUMERALS

10 Identification tags
11 Body
12 Identifier display area
13 identifier
14 Male part
15 Female part
16 Friction-fit lock mechanism
17 Linker
19 Pin
20 Computer vision
22 Cage
24 High-pass filter
25 Camera system
25I Infrared camera/Near-infrared camera
26 Video frame
27 LED screen
28 RFID reader
29 Time measuring device
30 Controller
32 Sensors
33 Multi-object tracking software
34 Physiological software
35 Cage
36 Inner housing assembly
37 Outer housing assembly
38 Housing assembly
39 Optical sensor
40 Tag applicator
41 Pliers
42A Jaw front part
42F First adjustable jaw mechanism
42M Second adjustable jaw mechanism
43 Grooves
44 Holes
50 Control panel for displaying
60 Laboratory animal identification and assaying kit
62 Instructions
63 Software interface

1. An animal tagging system for identifying and assaying multiple vertebrate animals, comprising:
a plurality of identification tags, each tag comprising a body (≤0.25 g) with an identifier display area (≥4×4 mm) bearing at least one number, letter, or symbol;
a male part with an offset pin;
a female part with a friction-fit lock mechanism adapted to receive said pin;
the identification tags applicable to animal ears or back skin and adapted to be readable by human and computer vision from at least 5 cm;
at least one controller adapted to monitor and record data from a plurality of sensors adapted to monitor the environment and the vertebrate animals;
a multi-object tracking software system operationally coupled to at least one optical sensor, adapted to track individual animals by detecting and reidentifying the identification tags, generating trajectories, and aggregating features, using at least one of appearance, motion, interaction, exclusion, and occlusion handling models, synchronized with sensor data via a time-measuring device; and
at least one physiological software system adapted to analyze sensor and tracking data to measure animal health parameters.

2. The animal tagging system of claim 1, wherein the identification tags are made of a biocompatible material selected from the group consisting of thermoplastic, metal, and composites.

3. The animal tagging system of claim 1, further comprising a tag applicator configured to apply the identification tags to ear or back skin, the applicator comprising pliers or a spring-coiled mechanism to hold and lock the male and female parts.

4. The animal tagging system of claim 3, wherein the tag applicator includes grooves or holes to release a disposable linker connecting said male and female parts during application.

5. The animal tagging system of claim 1, wherein the multi-object tracking software uses a deep learning (DL) algorithm adapted to recognize tag symbols, enhance individual animal identification in co-housed settings, and assess associated animal activity.

6. The animal tagging system of claim 1, wherein the multi-object tracking software uses a supervised learning algorithm adapted to recognize tag symbols, enhance individual animal identification in co-housed settings, and assess associated animal activity.

7. The animal tagging system of claim 1, wherein the multi-object tracking software further comprises a graph-based neural network (GNN) configured to model spatial and social interactions among the multiple vertebrate animals, using integrated tag data to maintain individual identities during complex group behaviors, such as crowding or occlusion events.

8. The animal tagging system of claim 1, further including a linker with each tag.

9. The animal tagging system of claim 1, wherein the identification tags are adapted to be illuminated by an overhead LED screen adapted to display a looming spot for vision assays and at least one infrared or near-infrared camera adapted to continuously record video.

10. The animal tagging system of claim 9, wherein said infrared or near-infrared camera includes a high-pass filter adapted to prevent interference from the LED screen's visible light.

11. The animal tagging system of claim 9, further comprising dynamically adjusting the interval of video frame capture by the at least one infrared or near-infrared camera based on the density or activity level of the vertebrate animals within the smart cage, toward optimizing data storage while maintaining accurate tracking of individuals identified by the plurality of identifier tags.

12. The animal tagging system of claim 1, further including a control panel adapted to display information recorded about at least one identification tag, which information may further be recorded about the animal to which said identification tag is attached.

13. The animal tagging system of claim 1, further comprising at least one RFID reader disposed on the outer housing assembly to supplement tag-based identification.

14. The animal tagging system of claim 1, wherein the controller is further configured to execute an automated calibration routine that adjusts the multi-object tracking software's recognition parameters based on the optical properties of the identification tag under varying cage lighting conditions.

15. A method for identifying and assaying multiple tagged vertebrate animals, comprising:
housing, feeding, and hydrating at least two vertebrate animals within a housing assembly;
applying identification tags to each animal's ear or back skin, each tag comprising a body (≤0.25 g) with an identifier display area (≥4×4 mm) bearing at least one number, letter, or symbol, readable by human and computer vision from at least 5 cm;
monitoring and recording data with a controller from sensors, including cameras, optical sensors, motion sensors, and force meters, the sensors monitoring the environment, devices, and animals;
tracking individual animals using a multi-object tracking software system coupled to an optical sensor, detecting and reidentifying tags, generating trajectories, and aggregating features, synchronized with sensor data via a time-measuring device;
assigning and storing sensor data to each animal based on tag identification.

16. The method for identifying and assaying multiple tagged vertebrate animals of claim 15, further comprising analyzing sensor and tracking data with a physiological software system.

17. The method for identifying and assaying multiple tagged vertebrate animals of claim 15, further including applying identification tags by way of using a tag applicator with a friction-fit lock mechanism to secure male and female parts through ear or back skin.

18. The method for identifying and assaying multiple tagged vertebrate animals of claim 15, further comprising supplementing tag-based identification with RFID readers adapted to confirm animal identities.

19. A laboratory animal identification and assaying kit, comprising:
a plurality of identification tags, each with a body (≤0.25 g), and an identifier display area (≥4×4 mm) bearing at least one number, letter, or symbol, a male part with an offset pin, a female part with a friction locking mechanism, and an optional linker, applicable to animal ear or back skin;
an identification tag applicator adapted to attaching tags;
a system defining a trackable space with inner and outer housing assemblies, and a controller operably coupled to at least one multi-object tracking software; and
instructions for applying identification tags and operating the system to monitor and assay multiple vertebrate animals.

20. The laboratory animal identification and assaying kit of claim 19, further comprising a software interface adapted for real-time visualization of individual animal trajectories and health parameters.
